(19) United States
(12) Patent Application Publication
(10) Pub. No.: US 2017/0251058 A1
(43) Pub. Date: Aug. 31, 2017

(54) Application Centric Distributed Storage System and Method

(71) Applicant: ioFabric Inc., Toronto (CA)

(72) Inventors: Rayan Zachariassen, Toronto (CA); Steven Lamb, Toronto (CA)

(21) Appl. No.: 15/506,334

(22) PCT Filed: Sep. 4, 2015
(86) PCT No.: PCT/CA2015/050847

§ 371 Date: Feb. 24, 2017

Related U.S. Application Data
(60) Provisional application No. 62/045,927, filed on Sep. 4, 2014.

(51) Int. Cl. H04L 29/08; H04L 12/879; H04L 12/24

(52) U.S. Cl. CPC H04L 67/1097; H04L 41/5009; H04L 41/20; H04L 67/16; H04L 49/901; H04L 67/1095

(57) ABSTRACT

A software defined storage network comprising one or more storage nodes, each storage node including a computer processor and one or more data storage devices; the one or more storage devices including a computer readable medium storing data partitioned into one or more volumes; wherein the one or more volumes are visible to at least a subset of the storage nodes and to non-storage nodes on the network; and a computer system in communication with the network having a computer processor executing instructions stored on a computer readable medium to define a plurality of actors providing a storage service; wherein each actor defines a virtual representation of at least one of the volumes and acts as a controller for each of the at least one data storage devices; wherein each of the plurality of actors places data for each volume on the storage devices according to at least one policy.

### RELATED APPLICATIONS

This application claims priority from U.S. Provisional Patent Application No. 62/045,927, filed Sep. 4, 2014, the contents of which are incorporated herein by reference.

### TECHNICAL FIELD

This invention relates generally to data storage. More specifically it relates to a system and method of partitioning and storing data on multiple storage resources in a way that enhances latency and protection parameters.

### BACKGROUND

Software defined storage (SDS) is a concept of computer data storage where the storage of digital data is managed by software rather than the storage hardware itself. Many operations previously managed by each independent hardware device are virtualized into software. Multiple storage hardware elements can be managed through software, with a central interface.

Storage and computational demands and workloads change continuously. Data requirements are constantly increasing. Current SDS systems are limited in several ways, exemplified by a lack of a sub-volume level of understanding of the data for most of the software features, so capabilities like snapshots and data tiering have to occur at the volume level not at the application or virtual machine level. This results from their adherence to legacy storage architecture limitations and volumes.

Quality of Service (QoS), if it is available, also is typically limited to a specific volume. This means that if a storage or application administrator wants to alter the current QoS setting of an application or virtual machine it needs to be migrated to another volume. The volume cannot adjust to the needs of the VM.

SDS tends to entirely replace the software services that are available on the storage system. In other words, SDS, as it currently exists, means that an organization is buying the feature twice. Once when it is “included” with the hardware, and again with the SDS solution. The justifications for this “double-buy” are that the IT professional can now manage storage through a single pane of glass and that future storage hardware can be purchased without these services. In reality it is hard to find a storage system without some form of data services.

Finally, most SDS architectures are dependent on a single- or dual-controller architecture. This limits the system's ability to scale and limits availability. These are critical features for the SDS design since it proposes to replace all data services. If these nodes fail all services stop.

There is accordingly a need in the art for improved software defined storage methods and systems.

### SUMMARY OF THE INVENTION

In an embodiment of the invention, there is provided a software defined storage network comprising one or more storage nodes, each storage node including a computer processor and one or more data storage devices; the one or more storage devices including a computer readable medium storing data partitioned into one or more volumes; wherein the one or more volumes are visible to at least a subset of the storage nodes and to non-storage nodes on the network; and a computer system in communication with the network having a computer processor executing instructions stored on a computer readable medium to define a plurality of actors providing a storage service; wherein each actor defines a virtual representation of at least one of the volumes and acts as an exclusive or non-exclusive controller for all or part of each of the at least one data storage devices; wherein each of the plurality of actors places data for each volume on the storage devices according to at least one policy; the at least one policy including maintaining a maximum latency target for each volume.

In one aspect of the invention, the at least one policy includes one of optimizing for a latency target, input/output operations per second and/or bandwidth.

In one aspect of the invention, the software service determines latency performance characteristics of each storage device based in part on the experience of one or more users of a volume accessing each of the storage devices.

In another aspect of the invention, the storage service implements the placement of data for each volume on the storage devices based on the latency target for each volume and on the determined latency characteristics for each storage device available to the volume.

In another aspect of the invention, multiple storage services are amalgamated into a single storage service.

In another aspect of the invention, the storage service permits replicated data to be placed on storage devices violating the maximum latency target determined for each volume, wherein a copy of the replicated data is available to maintain the latency target.

In another aspect of the invention, the software service provides a name of each volume consistent among each node where the volume is visible to applications.

In another aspect of the invention, placement information required to access or store data on each of the storage devices is in part available to the storage service and in part determined through a discovery protocol.

In another aspect of the invention, the software service provides the capability to determine whether the placement information determined through the discovery protocol is accurate, and upon determining the placement information is inaccurate, reinitializing the discovery protocol or otherwise determining correct placement information.

In another embodiment of the invention, there is provided a method for storing computer data on a storage network, the storage network comprising one or more storage nodes, each node including a computer processor and one or more storage device and each storage device including a computer readable medium storing data partitioned into one or more volumes visible to storage and non-storage nodes on the network, the method including implementing via computer executable instructions that when executed by a processor define a plurality of actors providing a storage service; wherein each actor defines a virtual representation of at least one of the volumes and acts as an exclusive or non-exclusive controller for each of the at least one data storage devices; placing, via at least one of the plurality of actors, data for each volume on the storage devices according to at least one policy.

In one aspect of this method, the at least one policy includes one of optimizing for a latency target, input/output operations per second and/or bandwidth.

In another aspect of the invention, the method further comprises determining performance characteristics of each storage device based in part on the experience of one or more users of a volume accessing each of the storage devices.

In another aspect of the invention, the method further comprises storing data for each volume on the storage devices based on the latency target for each volume and on the determined latency characteristics for each storage device available to the volume.

In another aspect of the invention, the method further comprises violating the maximum latency target determined for each volume when storing replicated data, provided a copy of the replicated data is available to maintain the latency target.

In another aspect of the invention, the software service provides a name of each volume consistent among each node where the volume is visible to applications.

In another aspect of the invention, placement information required to access or store data on each of the storage devices is in part available to the storage service and in part determined through a discovery protocol.

In another aspect of the invention the software service provides the capability to determine whether the placement information determined through the discovery protocol is accurate, and upon determining the placement information is inaccurate, reinitializing the discovery protocol or otherwise determining correct placement information.

In another embodiment of the invention, there is provided a storage system comprising multiple storage devices on one or more network attached storage nodes where data is partitioned into one or more volumes, with each volume visible [to applications] on a subset of the storage nodes and on non-storage nodes on the network, where data for each volume is placed on storage devices in order to maintain a maximum latency target determined for each volume.

In one aspect of the invention, the latency characteristics of each storage device that can participate in a volume is determined (measured or derived) in a way that is correlated with the experience of one or more users of the volume.

In another aspect of the invention, a storage service operates for each visible volume on a network attached node and the storage service decides, or is told, how to place data for a volume on the available storage devices based on the latency target declared for the volume and the known or declared or calculated latency characteristics of each storage device available to the volume.

In another aspect of the invention, multiple storage services are amalgamated into a single storage service making decisions for multiple visible volumes.

In another aspect of the invention, replicated data can be placed on storage devices that violate the maximum latency target determined for each volume because other copies of the replicated data are available to maintain the latency target.

In another aspect of the invention, the name of each visible volume is consistent among the nodes where the volume is visible to applications.

In another aspect of the invention, the storage devices may themselves be independent storage systems.

In another aspect of the invention, the placement information required to access or store data is only partially available to a storage service and that information must be determined through a discovery protocol.

In another aspect of the invention, the placement information determined through a discovery protocol may not be correct at the subsequent time of use, and with the mechanisms to realize this and use correct placement information.

According to another embodiment of the invention, there is provided a storage system comprising multiple storage devices on one or more network attached storage nodes, where data is partitioned into one or more volumes, where each storage device is represented by an actor that provides a storage service for one or more volumes that can have their data stored on [i.e. are eligible to use] said storage device.

In one aspect of the second embodiment, multiple storage services are amalgamated into a single storage service acting for multiple storage devices.

In another aspect of the second embodiment, the name of each volume is consistent among the nodes where the volume is visible to applications.

In another aspect of the second embodiment, each storage device may itself be an independent storage system.

Aspects described with respect to the method are equally applicable to those aspects described with respect to the system, and vice versa.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIGS. 1 and 2 are schematic system diagrams of the application centric storage system according to one embodiment of the invention.

### DETAILED DESCRIPTION

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

Furthermore, this description is not to be considered as limiting the scope of the embodiments described herein in any way, but rather as merely describing the implementation of various embodiments as described.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. Program code is applied to input data to perform the functions described herein and to generate output information. The output information is applied to one or more output devices, in known fashion.

Each program may be implemented in a high level procedural or object oriented programming or scripting language, or both, to communicate with a computer system. However, alternatively the programs may be implemented in assembly or machine language, if desired. The language may be a compiled or interpreted language. Each such computer program may be stored on a storage media or a device (e.g., ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including one or more diskettes, compact disks, tapes, chips, magnetic and electronic storage media, and the like. Non-transitory computer-readable media comprise all computer-readable media, with the exception being a transitory, propagating signal. The term non-transitory is not intended to exclude computer readable media such as a volatile memory or RAM, where the data stored thereon is only temporarily stored. The computer usable instructions may also be in various forms, including compiled and non-compiled code.

It should also be noted that, as used herein, the wording and/or is intended to represent an inclusive-or. That is, X and/or Y is intended to mean X or Y or both, for example. As a further example, X, Y, and/or Z is intended to mean X or Y or Z or any combination thereof.

Definition of Key Terms

While most terminology used in this description will have their plain and common meaning as used in the art of network and/or storage computer systems, certain key terms are defined below for added clarity and understanding of the invention.

Storage Node—a storage node includes any server or computer system providing access to one or more storage devices in a network.

Non-Storage Node—a non-storage node is a network server having as its primary function a task other than data storage.

Application Centric—application centric is defined in the context of this description as the ability to make data storage decisions and carry out data storage functions based on the requirements of applications accessing the data, or to otherwise optimize data storage functions from the applications perspective.

Actor—an actor is a virtual or software representation of a volume stored on one or more storage devices, which also acts as a software-implemented controller for the storage device. It may or may not be stored or implemented on the storage device itself.

### Preferred Embodiments

The application centric distributed storage system according to the invention manages data storage on a large number of storage devices. It may be used to amalgamate an existing system of multiple storage devices into one storage service, and can absorb additional storage devices added at a later time. The system automatically responds to user settings to adjust and continuously monitor data storage to satisfy the user's computing and/or data storage requirements. These requirements broadly define a policy for which the storage is optimized in various embodiments of the invention. The policy could be optimized for a target latency, or IOPS (input/output per second), or bandwidth. Minimum and maximum limitations are used for device selection and throttling. For example, the system could throttle at max IOPS and prevent placing data on a storage device that is slower than a minimum IOPS.

The distributed model could be similar to the hyper-converged and web-scale architectures that the compute tier employs. This could be done by deploying agents within physical servers or virtual machines that can scan all the available storage resources. Storage administration should include assigning capacity, performance level and data protection requirements. From this policy information for each volume the invention automatically places data in storage devices expected to provide the required service and monitors and moves or copies data as necessary to maintain the required service. The architecture of having such monitoring and control decisions made by each actor in their local context allows the invention to scale without architectural limits. This architecture allows storage policies to scale across storage systems, in a shared-nothing model.

The application centric distributed storage system is a more efficient storage system that may automatically manage and standardize multiple storage services with varying hardware configurations, in such a way as to meet a user's defined performance targets.

The application centric distributed storage system may improve data storage automation by having storage automatically adjust to conditions occurring in the environment. (eg: allocate more flash storage to a data set seeing an increase in read and/or write activity. Or increase data protection based on activity—something accessed continuously may be backed up continuously) It may also deliver orchestration: network and storage infrastructure are pre-programmed to deliver an intended service level. QoS (Quality of Service) is the mechanism that drives, allows user to set service levels, and then adjusts to maintain those service levels as the environment around changes.

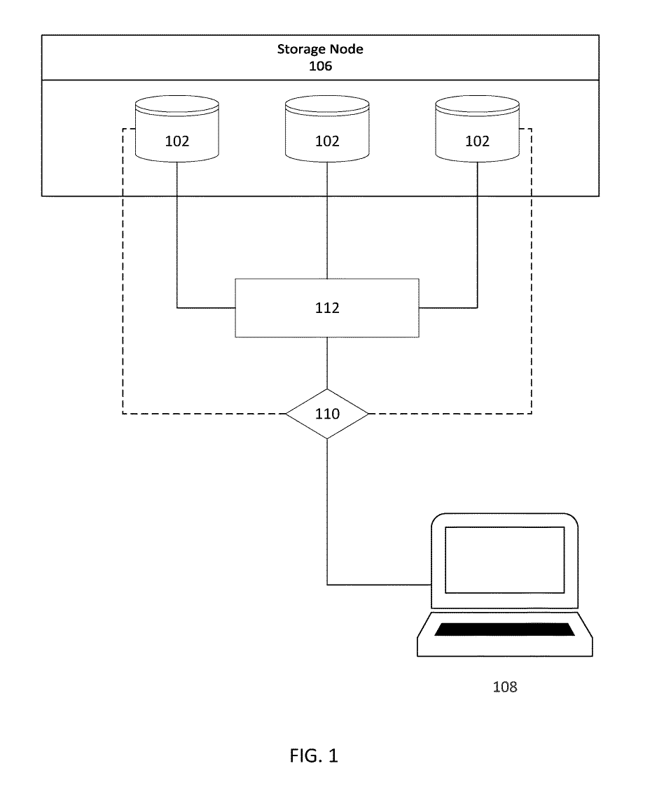

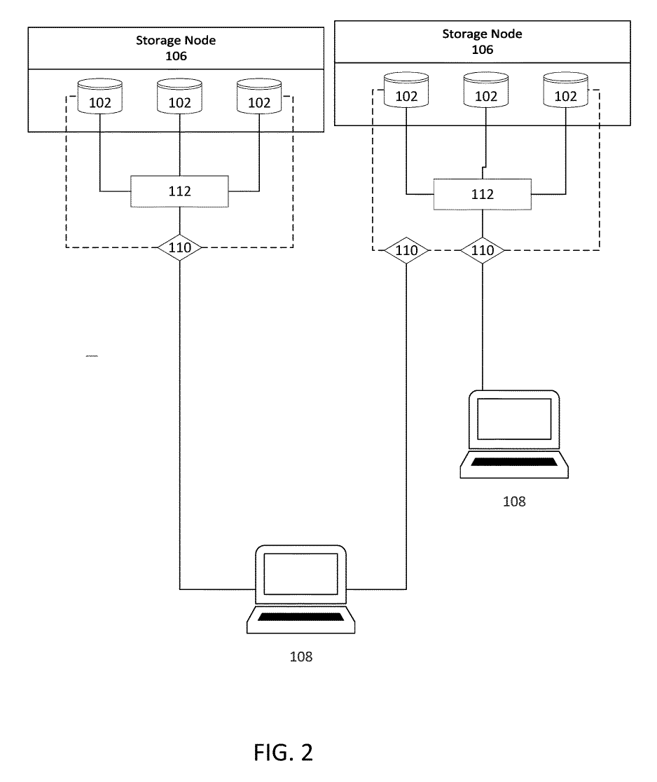

FIG. 1 is a schematic diagram of a specific application centric distributed storage system 100 for storing data on a set of distributed storage devices comprising one or more storage devices 102, a computer network 104, storage nodes 106, computer system 108, actors 110. FIG. 2 is a generalized version of FIG. 1 showing a plurality of the aforementioned elements. The system in FIG. 2 is scalable and may include as many of each elements as is practically and economically feasible. In implementation, actors 110 are virtual representations of a volume 112 which present a virtualized volume to a specific application and acts as controllers by managing part of each of the storage devices where the underlying volume 112 is stored. Actors 110 could be executed from computer system 108. Computer system 108 may generally be a network server through which user computers access the network.

The system 100 uses a distributed metadata model and decentralized decision making, in that each volume 112 is represented by an actor 110 that understands which storage devices 102 participate in the volume 112, and communicates with other actors 110 for those volumes, and makes independent queries and decisions about the state of other actors (110) and the data they are responsible for. Specifically, computer system 108 (or a plurality of computer systems represented by system 108) contains a set of actors 108, where each individual actor is a virtual representation of a volume 112. These actors are in communication with each other such that each is aware of other actors (and by extension, other storage devices) used for particular volumes of data.

Storage device 102 may be any hardware device capable of storing data including hard drives, flash drives, solid state drives, storage class memory and the like. Storage device 102 may also be a cloud-based storage device or any other storage service visible to a particular storage node. System 100 may contain a combination of different types of storage devices 102. Each storage device 102 may have unique technical specifications including memory capacity, read/write speed, lifespan, etc. Each storage device 102 may have unique known latency characteristics, or said latency characteristics may be determined. Additional storage devices 102 may be added to the system 100 at any time and the system 100 may maintain latency targets.

Communication network 104 may be substantially any public or private network, wired or wireless, and may be substantially comprised of one or more networks that may be able to facilitate communication between themselves and between the various parts of system 100.

Storage node 106 may be any electronic device attached to the communication network 104 capable of receiving or transmitting data. Storage node 106 may be a standard server having at least one storage node behind it. In an exemplary embodiment, storage node 106 is a physical or virtual Linux server.

Computer user system 108 may be a combination of one or more computers running software applications that require accessing stored digital data. Any computer may have a number of physical and logical components such as processors, memory, input/output interfaces, network connections, etc. System 108 may include a central computer that may control the operation of the system 100 through a dashboard interface.

One or more computers of user system 108 may run the storage service software. This is where the dashboard will be run from and the settings will be determined.

User system 108 may comprise one or more human operators, such as an IT employee, capable of using software to adjust desired storage system requirements as needed. Operators (administrators) may define QoS policies for individual applications or groups of applications through the dashboard. QoS policies may include performance (IOPS, latency, bandwidth), capacity, and data protection (e.g. replication, snapshots) levels.

Actor 110 may be a software module, in part representing a storage device 102. The actor 110 may keep track of which volumes the associated storage device 102 participates in. Actor 110 may communicate with other actors for associated volumes. Actor 110 may make queries and decisions about the state of other actors and the data with other associated actors 110.

The actor 110 may determine how to place data for a volume on storage devices 102 based on latency targets for the volume and latency characteristics of the storage device. This determination is made at the actor level and occurs without specific user applications being aware of the presence or actions of the actors 110.

Each actor 110 also understands the policies for each volume and promotes or demotes data among the actors 110 for a particular volume, including itself, based on their latency distance from itself and how that relates to the latency policy for the volume. For greater emphasis, a volume of data as represented by, and known to the actors, is a virtualized volume, which may physically exist in one or more of the individual storage devices 102. This virtualization of the volume definitions permits the actors to manipulate where data is physically stored while maintaining the volume definitions at the application level, thus resulting in the application-centric data storage system. Applications see consistent definitions and mappings of volumes, even where data itself may be moved or manipulated between different specific hardware storage devices.

The plurality of actors 110 acting together form a storage service, whereby each actor defines a virtual representation within the storage service of its respective volume and acts as a controller for that data storage device. The term controller is used to refer to the function of the actors managing part of for each of the storage devices where the volume they represent has an interest. The software service determines performance characteristics of each storage device based in part on the experience of one or more users of a volume accessing each of the storage devices. This could be accomplished by characterizing idle performance of storage devices and/or by real-time measurements of the storage device performance from the perspective of an application.

The actors 110 may be understood as providing the functionality of a volume manager. In this context, there is an actor, or a volume manager, running at each access point for the volume. An access point is where the storage service is exposed. For example, a traditional block device volume might be exposed simultaneously on three nodes, so there would be three actors running for that volume, all in communication with each other. Communication between the actors could be implemented using TCP sessions with a known protocol. The actors all have to talk to each other to ensure consistency of allocations and data migrations/movements. In addition, the actors, both internally within a volume and externally between volumes, compete with each other for storage resources. The actors individually manage QoS on behalf of their application (ie. talking to the volume through a local access point), but when communicating amongst each other within these confines creates the architecture and opportunity to scale the system up because the complexity does not grow with system size it grows for each volume with the number of storage devices that participate in the volume.

The storage service implements the placement of data for each volume on the storage devices based on the performance target for each volume and on the determined performance characteristics for each storage device available to the volume.

The storage service permits replicated data to be placed on storage devices violating the maximum latency target determined for each volume, provided a copy of the replicated data is available to maintain the latency target. This allows the storage service to deemphasize data replication applications or back-up instructions from other applications so as to optimize latency targets for applications using the data for normal operations.

The behavior of the entire system 100 is therefore the aggregated behavior of a number of actors 110 making independent decisions on placement of data based on where the data is accessed from, the nature of the access (reads or writes), the performance policy, and each actor's 110 understanding of the state of its correspondent actors 110. The information used by any actor 110 to make a placement or retrieval decision may not be correct at the time of the decision or its implementation, and the invention is designed to assume this and self-correct. The actors are in constant communication with each other and implement failure handling mechanisms to ensure consistency. In its simplest implementation, if an actor drops out, its data is considered lost. However, it is also contemplated that the data of an actor that has dropped out may be resynchronized.

The implementation of actors 110 as herein described results in storage virtualization that is responsive to real-time parameters and characteristics of the physical storage devices in the system, all the while requiring no adaptation by applications accessing the data. Applications view the virtualized storage system as virtual volumes indistinguishable from physical volumes, even though the actual data storage could be spread across multiple storage devices as described above.

The system 100 software may have multiple automated processes and abilities:
the ability to place active data on high-performance media for fast access, and stale data onto inexpensive capacity media.
generate alerts if QoS levels are violated, and may automatically make adjustments to attain the permitted levels. Adjustments generally consist of moving data to a storage device that complies with QoS requirements. Alternatively, in the case of data protection, adjustments may include copying the data.
partition data into one or more volumes (named collection of data) and determine the location(s) where each volume may be placed on one or more of the storage devices 102. The determination may be made using calculated, preset performance targets (of the volume) and known performance characteristics of each storage device 102.
volumes may be placed on storage devices in such a way in order to maintain a maximum performance target determined for each volume.
each volume may have a name or identifier, such that each visible volume is consistent among the nodes where the volume is visible to applications.
use a discovery protocol to determine the data placement information, without such discovery protocol the placement information is only partially available to a storage service. The software service provides the capability to determine whether the placement information determined through the discovery protocol is accurate, and upon determining the placement information is inaccurate, reinitializing the discovery protocol or otherwise determining correct placement information.
detect the addition of new storage devices 102 and automatically use them, possibly subject to policy constraints, for existing and new volumes, which may result in volume data being moved to the new storage devices.
manage replicated data, including placing replicated data on storage devices 102 in a way that violates performance targets.

The system 100 includes a data protection mechanism (nominally replication) that is enforced on every write of data, but because placement decisions are based on fulfilling a performance policy the placement may be asymmetrical in that only one high performance location is required to fulfill a high performance read request, and multiple high performance locations are required to fulfill a high performance write request with full protection (positive write acknowledgements from remote nodes 106) on the data.

Even though the conceptual design of the system 110 uses independent actors 110 for each volume, in a practical implementation these may be joined into a single process or a number of processes that is smaller than the number of volumes represented, without changing the essence of the invention.

Performance settings may include placing active data on performance media near compute and stale data on appropriate capacity media.

QoS settings may include minimum/maximum, target, and burst for TOPS, latency, and bandwidth, as well as data protection and data placement policies. (Real-time setting and enforcement of latency, bandwidth, and performance over various workloads.)

Capacity management may include thick provisioning and elastic storage without a fixed capacity.

Embodiments of the invention as herein described provide a deeper granularity than prior art volume definitions or LUN. The solution makes decisions about volume storage definitions based QoS parameters. QoS-driven data movement decisions are made at an extent size granularity which can be quite small, and the effect of data movement is to change the storage device(s) data is physically placed on, not to move the data to a different volume.

For example, if a move from a first level to a second level is requested then the flash allocation to that dataset is transparently increased. Subsequently if the priority of an application is raised, then the flash allocation may actually be larger than the hard disk allocation, almost eliminating access from non-flash media. Further, if an upgrade of an application's QoS occurs once more, then its dataset is 100% allocated from flash, eliminating any non-flash media access.

Tiers are not limited to flash and hard disks. For example, DRAM could be accessed as another tier of storage that can be allocated to these various types of QoS policies, allowing for even greater storage performance prioritization.

QoS is also not limited to performance. Another QoS parameter could be set for data protection levels. For business critical data, a QoS setting could require that data be asynchronously copied to a second, independent storage system creating a real-time backup. For mission critical data, a QoS setting could require a synchronous copy of data be made to a second system.

Another data protection capability is limiting the storage devices participating in a volume to a number or to a set that has particular relationships to the sets of storage devices used for other volumes, in order to limit the total effect of particular storage devices or computers with storage devices failing. For example in a distributed hash table based storage system because all volumes keep data on all nodes, one more failure than the system is designed for will almost certainly destroy data on all volumes in the system, whereas in the invention, even without special policies in this regard, the data destroyed is only that which certain volumes keep on the failed device. The sophistication of this mechanism can be improved over time by coordination between actors that have choices in which storage devices to use for a volume.

This concludes the description of the various preferred embodiments of the invention, which are not to be limited by the specific embodiments described. Rather, the invention is only limited by the claims that now follow.

1. A software defined storage network comprising:
one or more storage nodes, each storage node including a computer processor and one or more data storage devices;
said one or more storage devices including a computer readable medium storing data partitioned into one or more volumes;
wherein said one or more volumes are visible to at least a subset of said storage nodes and to non-storage nodes on the network;
a computer system in communication with the network having a computer processor executing instructions stored on a computer readable medium to define a plurality of actors providing a storage service; wherein each actor defines a virtual representation of one volume and acts as an exclusive or non-exclusive controller for each of said at least one data storage devices where part or all of the one volume is stored;
wherein each of said plurality of actors places data for each volume on said storage devices according to at least one policy.

2. The storage network of claim 1, wherein the at least one policy includes one of optimizing for a target, maintaining restrictions on latency, input/output operations per second and/or bandwidth.

3. The storage network of claim 1, wherein said software service determines performance characteristics of each storage device based in part on the experience of one or more users of a volume accessing each of the storage devices.

4. The storage network of claim 3, wherein the storage service implements the placement of data for each volume on said storage devices based on the performance target for each volume and on the determined performance characteristics for each storage device available to the volume.

5. The storage system of claim 4, wherein multiple storage services are amalgamated into a single storage service.

6. The storage system of claim 1, wherein the storage service pelt tits replicated data to be placed on storage devices violating the performance target determined for each volume, wherein a copy of the replicated data is available to maintain the performance target.

7. The storage system of claim 1, wherein the software service provides a name of each volume consistent among each node where the volume is visible to applications.

8. The storage system of claim 1, wherein placement information required to access or store data on each of the storage devices is in part available to the storage service and in part determined through a discovery protocol.

9. The storage system of claim 8, wherein the software service provides the capability to determine whether the placement information determined through the discovery protocol is accurate, and upon determining the placement information is inaccurate, reinitializing the discovery protocol or otherwise determining correct placement information.

10. The storage system of claim 1, wherein more than one actor defines a virtual representation of the same volume.

11. The storage system of claim 1, wherein two or more of said plurality of actors are merged into a single process.

12. A method for storing computer data on a storage network, the storage network comprising one or more storage nodes, each node including a computer processor and one or more storage device and each storage device including a computer readable medium storing data partitioned into one or more volumes visible to storage and non-storage nodes on the network, the method comprising:
implementing via computer executable instructions that when executed by a processor define a plurality of actors providing a storage service; wherein each actor defines a virtual representation of one volume and acts as an exclusive or non-exclusive controller for each of said at least one data storage devices where the one volume is stored;
placing, via at least one of said plurality of actors, data for each volume on said storage devices according to at least one policy.

13. The method of claim 12, wherein the at least one policy includes one of optimizing for a target, maintaining restrictions on latency, input/output operations per second and/or bandwidth.

14. The method of claim 12, further comprising determining performance characteristics of each storage device based in part on the experience of one or more users of a volume accessing each of the storage devices.

15. The method network of claim 14, further comprising storing data for each volume on said storage devices based on the performance policy for each volume and on the determined performance characteristics for each storage device available to the volume.

16. The method of claim 12, further comprising violating the performance policy determined for each volume when storing replicated data, provided a copy of the replicated data is available to maintain compliance with the performance policy.

17. The method of claim 12, wherein the software service provides a name of each volume consistent among each node where the volume is visible to applications.

18. The method of claim 12, wherein placement information required to access or store data on each of the storage devices is in part available to the storage service and in part determined through a discovery protocol.

19. The method of claim 16, wherein the software service provides the capability to determine whether the placement information determined through the discovery protocol is accurate, and upon determining the placement information is inaccurate, reinitializing the discovery protocol or otherwise determining correct placement information.

20. The method of claim 12, wherein more than one actor defines a virtual representation of the same volume.

21. The method of claim 12, wherein two or more of said plurality of actors are merged into a single process.
